(19) United States
(12) Patent Application Publication
(10) Pub. No.: US 2017/0329574 A1
(43) Pub. Date: Nov. 16, 2017

(54) DISPLAY CONTROLLER

(71) Applicant: Atmel Corporation, San Jose, CA (US)

(72) Inventors: Guilliaume Pean, Aix en Provence (FR); Renaud Tiennot, Aix en Provence (FR); Vincent Debout, La Ciotat (FR); Vincent Chanel, Rousset (FR)

(21) Appl. No.: 15/154,287

(22) Filed: May 13, 2016

(51) Int. Cl. G06F 5/14; G06F 3/06; G06T 1/60; G06F 13/28

(52) U.S. Cl. CPC G06F 5/14; G06T 1/60; G06F 3/0673; G06F 13/28; G06F 3/0619; G06F 3/0653; G06F 3/064; G06F 2205/126

(57) ABSTRACT

The disclosure describes a display controller and a method that includes monitoring a fill-level of a first in, first out (FIFO) block in the display controller, generating a regulation signal that depends on the fill-level of the FIFO block, and regulating, based on the regulation signal, access to a system interconnect by a master unit other than the display controller.

### FIELD OF THE DISCLOSURE

The present disclosure relates to display controllers.

### BACKGROUND

Master/slave communication is a form of communication protocol where one device or process (e.g., the master) has unidirectional control over one or more other devices (e.g., the slaves). Sometimes such communications may be referred to as primary/secondary. Bus mastering is a feature supported by some bus architectures that enables a device (e.g., a master device) coupled to the bus to initiate transactions. Some types of bus architectures allow multiple devices to serves as masters because it can improve performance.

### SUMMARY

The present disclosure describes display controllers.

In one aspect, for example, the disclosure describes a display controller that includes a first in, first out (FIFO) block and a regulation signal generator coupled to the FIFO block. The regulation signal generator is operable to generate a regulation signal based on a fill-level of the FIFO block, and the regulation signal is configured to regulate access, by a master unit, to a system interconnect.

In another aspect, for example, the disclosure describes a method that includes monitoring a fill-level of a first in, first out (FIFO) block in a display controller, generating a regulation signal that depends on the fill-level of the FIFO block, and regulating, based on the regulation signal, access to a system interconnect by a master unit other than the display controller.

In a further aspect, the discloser describes a microcontroller that includes an embedded display controller, which includes a regulation signal generator operable to monitor a fill-level of the FIFO block and to generate a regulation signal that depends on the fill-level of the FIFO block, wherein the regulation signal is configured to regulate access to the bus by one or more master units.

Other aspects, features, and advantages will be readily apparent from the following detailed description, the accompanying drawings, and the claims.

### BRIEF DESCRIPTION OF THE DRAWINGS

FIG. 1 is a block diagram of an example system that includes an embedded display controller, in accordance with an embodiment.

FIG. 2 is a block diagram of an example display controller, in accordance with an embodiment.

FIG. 3 is a flow chart of an example method of managing access to a system interconnect in the microcontroller, in accordance with an embodiment.

FIG. 4 illustrates a timing diagram associated with generating a regulation signal based on monitoring the fill-level of a first-in-first-out (FIFO) block in an example display controller, in accordance with an embodiment.

FIG. 5 is an example graphics engine bus interface, in accordance with an embodiment.

### DETAILED DESCRIPTION

In an example scenario, master/slave communications allow a device or process to have unidirectional control over one or more other devices. An embedded display, such as a liquid crystal display (LCD) controller, which is operable to fetch data, for example, in an external memory and transmit it to a LCD panel, is an example of a master in some microcontrollers. The microcontroller, however, may include additional masters that compete for access to the system bus. In some cases, a bus matrix provides an arbitration technique that reduces latency when conflicting requests for access to the bus occur, for example, when two or more masters try to access the same slave at the same time.

To arbitrate access to the system bus, various techniques can be used. In some approaches, a bus interface, acting as a slave, uses a round robin algorithm by default to schedule accesses of masters to itself. This can be critical if other masters request access to the bus interface and thus reduce the bandwidth for the display controller. Such a situation can lead, for example, to a buffer underflow in the display controller, resulting in loss of synchronization. A typical symptom of a buffer underflow is that the image on the screen is shifted vertically or horizontally.

As described in greater below, in a microcontroller that includes an embedded display controller, a regulation signal can be generated based on the fill-level of an output first-in-first-out (FIFO) block in the display controller. The regulation signal, which can vary depending on the fill-level, is forwarded to bus interfaces for other masters in the microcontroller and is used to control the rate and bandwidth of the other masters' transactions on the system interconnect (e.g., system bus). The technique can, in some cases, help prevent the LCD display from suffering pixel underrun. Further, the regulation mechanism can be transparent when the LCD requires only a limited amount of system bandwidth.

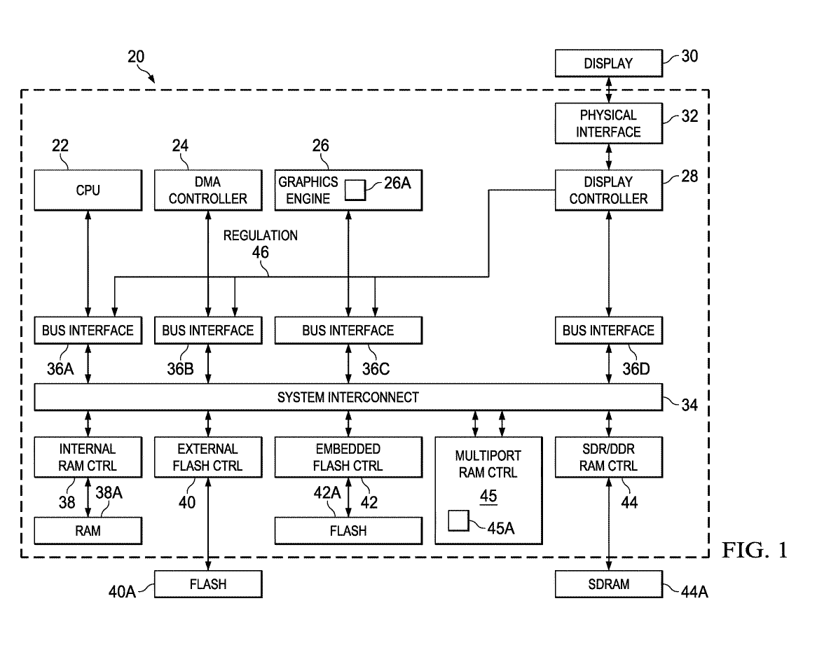

FIG. 1 illustrates various components of a microcontroller (MCU) 20, which in some embodiments, provides multiple interfaces using Advanced Microcontroller Bus Architecture (AMBA) technology to provide high-speed, low-latency memory accesses. AMBA is an open-standard, on-chip interconnect specification for the connection and management of functional blocks in system-on-a-chip (SoC) designs. Other MCU architectures can be used as well. In the illustrated example, the MCU includes various masters, including a central computing unit (CPU) 22, a direct memory access (DMA) controller 24, a graphics engine 26 and an embedded display controller 28, for example, a LCD controller. The CPU 22, for example, can execute instructions and operate on data to perform specified tasks. The DMA controller 24 can move data from one memory location to another memory location. The graphics engine 26 is operable to read and write image data (e.g., pixels). The display controller 28 is operable to read pixels for displaying a frame on a display screen 30. The microcontroller 20, including the foregoing master devices, can be implemented, for example, in a monolithic silicon chip.

The various masters, including the CPU 22, the DMA controller 24, the graphics engine 26 and the display controller 28 are coupled to a system interconnect (i.e., a system bus) 34 by way of respective bus interfaces 36A, 36B, 36C, 36D. The system interconnect 34 can implement, for example, a multi-layer Advanced High-performance Bus (AHB) protocol based on the AHB-Lite protocol that enables parallel access paths between multiple AHB masters and slaves (e.g., memory controllers). The AHB-Lite protocol is a subset of AHB, which is a bus protocol introduced in AMBA. The bus interfaces 36A-36D and system interconnect 34 can support, for example, various access priority levels, including latency-sensitive and latency-critical levels, in order to increase the overall processor performance while securing high-priority latency-critical requests from peripherals. Some implementations, for example, use a four-level encoding of the priority: latency critical, which is the highest level of access priority; latency sensitive, which is the second highest level of access priority; bandwidth shortage, which is the third highest level of access priority; and regular delivery, which is the lowest level of access priority.

In FIG. 1, the bus interfaces 36A, 36B, 36C, 36D are shown as separate from the master devices 22, 224, 26, 28. However, in some implementations, each bus interface can be integrated into the respective master device. For example, the bus interface 36D can be integrated into, and form part of, the display controller 28. Although each of the various master devices 22, 24, 26, 28 can use a communication protocol that differs from the communication protocols used by the other master devices, all the master devices should use the same communication protocol when communicating with the system interconnect 34. Thus, each bus interface 36A, 36B, 36C, 36D translates bus requests from the associated master device 22, 24, 26, 28 to the protocol used in the system interconnect 34.

Various slave devices also can be coupled to the system interconnect 34. For example, as shown in FIG. 1, an internal random access memory (RAM) controller 38, an external flash memory controller 40, an embedded flash memory controller 42 and/or a single data rate (SDR) or double data rate synchronous dynamic (SDR/DDR) RAM controller 44 can be coupled to the system interconnect 34. Some implementations also include a multiport random access memory controller 45 operable to provide a bounded latency response to masters' requests. The multiport RAM controller 45 has two or more bus slave interfaces, which allows at least two masters to access RAM at the same time. Latency represents the duration between the time when an access is presented to the multiport RAM controller 45 and the time when the multiport RAM controller 45 responds. A bounded latency response means that the latency cannot exceed a specified amount of time (e.g., 50 ns, in which case the latency will be between 0 ns and 50 ns).

The two-dimensional graphics engine 26 is operable in some implementations to fill, copy, blend and raster multiple memory areas (e.g., internal RAM 38A accessible through the RAM controller 38, internal flash memory 42A accessible through the embedded flash controller 42, external flash memory 40A accessible through the external flash controller 40, or external SDRAM 44A accessible through the external RAM controller 44). The graphics engine 26 is operable, in some cases, to use a memory- mapped ring buffer 45A (e.g., a memory area allocated at initialization time) to read commands issued by the CPU 22. For example, the CPU 22 can communicate with the graphics engine 26 through a memory mapped ring buffer 45A implemented, for example, as a FIFO buffer that is filled by the CPU 22 and read by the graphics engine 26. The ring buffer 45A can be mapped at a base address and can have a predefined length. In some implementations, the CPU 22 writes a batch of commands in the ring buffer 45A and updates a write pointer located, for example, in graphics engine registers 26A. When the graphics engine 26 detects that the write pointer has been updated, the graphics engine 26 starts reading the commands up to that pointer. Upon completion, the graphics engine 26 updates its internal read pointer. The CPU 22 can read the pointer and compute the amount of space available in the ring buffer 45A, using the difference in the read and writer pointers. The write pointer preferably is updated only when commands are written successfully to memory by the CPU 22, and the read pointer preferably is updated only when the commands have been read from the memory by the graphics engine 26. The graphics engine 26 thus can be used, for example, to render fonts, create a two-dimensional scene with bitmaps, convert an image to greyscale, or blend multiple layers, each of which has, for example, a frame buffer, a window position and a depth position.

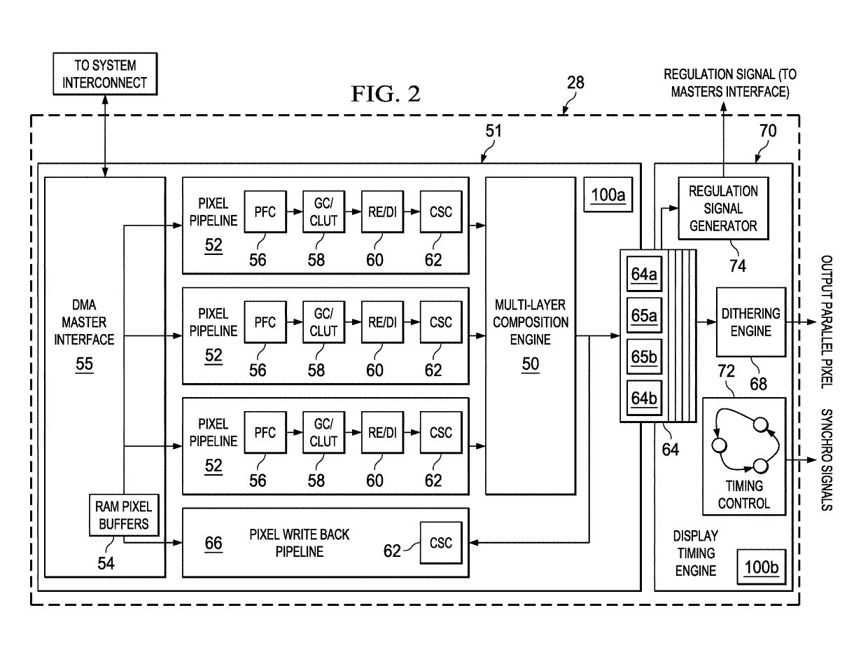

As mentioned above, the display controller 28 is coupled to the system interconnect 34 as a master device for reading pixel data. With reference now to FIG. 2, the display controller 28 includes a DMA master interface 55 for coupling to the system interconnect 34. The DMA master interface 55 in FIG. 2 corresponds to the bus interface 36D of FIG. 1, except that the interface 55 is shown as being integrated into the display controller 28. The DMA master interface 55 can include one or more finite state machines that implement a bus protocol (e.g., the AHB protocol). Thus, the DMA master interface 55 implements the bus protocol and facilitates coupling of the display controller 28 to the system interconnect 34. The display controller 28 is operable to retrieve image data (e.g., a stream of pixels) from a display buffer 54 in the DMA master interface 55 and transmit it, by way of physical interface 32, to a LCD panel or other display screen 30 that is operable to display the data.

According to some implementations, the DMA master interface 55 is operable to start reading pixels at the beginning of a display refresh period. The DMA master interface 55 stores the attributes of the different frame buffers required to create the final displayed frame. Frame buffer attributes define the frame buffer and can include, for example, a frame buffer memory location (e.g., an address in memory where the pixels are located) and a pixel format (e.g., indexed colors, RGB 16-bit, RGB 24-bit, RGB 32-bit, or YCbCr video mode). Here, YCbCr refers to a family of color spaces used as a part of the color image pipeline in video and digital photography systems, where Y is the luma component, and Cb and Cr are the blue-difference and red-difference chroma components respectively). The frame buffer attributes also can define the memory stride, which refers to a programmable amount of data that can allow, for example, non-contiguous frame buffer access to support picture-in-picture, map scrolling and/or screen rotation. Accordingly, the DMA master interface 55 has enough information to issue bus read transactions to retrieve the required stream of pixels from memory.

In some instances, the process flow includes the following operations. The DMA interface 55 issues a read transaction, which is propagated through the system interconnect 34. The read transaction targets a memory location (e.g., internal memory 38A, 42A or external memory 40A, 44A). The appropriate memory controller (e.g., controller 38, 40, 42 or 44) returns the data stream (e.g., the pixels), and the data is routed from the memory through the interconnect 34 to the DMA master interface 55. When the image data stream reaches the DMA master interface 55, the pixels are locally stored in the RAM pixel buffers 54. The locally stored image data then can be sent to pixel pipelines 52 for further processing, as described below.

In the illustrated example, the display controller 28 is operable to integrate multiple layers (e.g. a base layer and one or more overlay layers of image data) that are blended together in a multi-layer composition engine 50 (see FIG. 2). Each layer includes a path 52, sometimes referred to as a pixel pipeline, between the local RAM pixel buffers 54 and the composition engine 50. The number of layers, and thus the number of pixel pipelines 52, can vary depending on the implementation.

In the illustrated example, each layer of image data has its own pixel format (e.g., indexed color, 16-bits per pixel (bpp), 24-bpp, 32-bpp, or YUV which defines color space in terms of one luma (Y) and two chrominance (UV) components)), whereas the blending operation uses a common pixel format. To accomplish the conversions to the common pixel format, in the illustrated example, each pixel pipeline 52 includes a pixel format converter (PFC) 56 operable to expand colors to 32 bpp in the alpha, red, green and blue (ARGB) color space, a gamma correction/color look up table (GC/CLUT) module 58, a resampling engine (RE/DI) 60, and a color space conversion (CSC) module 62. The CSC 62 is operable to change the color space from YUV to red, green and blue (RGB). In a given pipeline 52, the output from the PFC 56 is provided to the GC/LUT 58, the output of the GC/LUT 58 is provided to the resampling engine 60, and the output of the resampling engine 60 is provided to the CSC 62. The color lookup table (CLUT) can be implemented, for example, as 256 RAM-based lookup table entries that are selected when the color depth is set to 1, 2, 4 or 8 bpp. In some instances, the color lookup table 58 can be used for gamma correction, where each color channel (e.g., red channel, green channel and blue channel) is an index in the table, and the output is the gamma corrected channel value.

The PFC 56 is operable to expand the layer pixel format to the 32-bit ARGB format, which uses 8-bits for the alpha component, and 8-bits for the red component, 8-bits for the green component, and 8-bits for the blue component. Conversion for YUV-YCbCr format involves additional processing (e.g., chrominance up-sampling, color space conversion and/or de-interlacing). These operations can be combined in the hardware resampling engine 60. The resampling engine 60 can up-sample and de-interlace the YUV stream. Programmable color space conversion then transforms the YUV data to the 32-bit ARGB common format.

Pixels from the multiple pipelines 52 can be blended together by the multi-layer composition engine 50, and the blended pixel (e.g., in 24-bit RGB format) then is written to an output FIFO block 64, which stores the blended pixel prior to display. The multi-layer composition engine 50 can be implemented, for example, as a hardware submodule operable to gather multiple input pixel streams from the pixel pipelines 52. The multi-layer composition engine 50 stores information about the layers' positions on the display screen 30 (e.g., the X-Y coordinates where each window begins). In some cases, the multi-layer composition engine 50 paces the different pixel streams of each layer, and performs per-pixel blending at each X-Y screen position. For example, there can be multiple layers each of which has a different depth (e.g., background, video, cursor, secure layer, video, and/or foreground). These layers can be blended, for example, in accordance with their depth and their alpha blending value (e.g., when the alpha value is zero, the layer is transparent; when the alpha value is 255, the layer is opaque). This operation can be repeated for each layer so as to create the frame. In some cases, the blended pixel is written to a pixel write back pipeline 66.

In the illustrated example, the per-pixel blending, at coordinate X-Y of the display screen 30, is a pipelined operation. The pipeline can be controlled, for example, using a FIFO full flag. When the flag is false (e.g., there is enough space in the FIFO 64 to write one pixel), the pipeline is active; when the flag is true (e.g., the FIFO 64 is full), the pipeline is stalled.

The output FIFO block 64 can be implemented, for example, as two FIFO buffers 64A, 64B operable in dual scan configuration, and configured as a single FIFO buffer when used in single scan configuration. The FIFO buffers 64A, 64B can be implemented, for example, in RAM to facilitate storage of a large number of entries. In some cases, the FIFO block 64 operates as a circular queue that includes a read pointer 65A and a write pointer 65B. The FIFO block 64 also can facilitate clock domain crossing between a system clock 100A (e.g., 200 MHz) used by components of the display controller 28 within box 51 and a pixel clock 100B (e.g., 30 MHz) used by components in the display timing engine 70. Thus, the write pointer (producer) 65B can be updated (e.g., on the system clock) when a blended pixel is written to the FIFO block 64; the read pointer (consumer) 65A can be updated (e.g., on the pixel clock) when a pixel is read from the FIFO bock 64. In particular, when a pixel is pushed into the FIFO block 64, the write pointer 65B is incremented; when a pixel is pushed out of the FIFO block 64, the read pointer 65A is incremented. The difference between the two pointers 65A, 65B can be used by logic in a regulation signal generator 74 to determine and monitor the full/empty condition of the FIFO block 64. When the write pointer 65B reaches the end of the FIFO block's buffer, the write pointer wraps to the beginning. Likewise, when the read pointer 65A reaches the end of the FIFO block's buffer, the read pointer wraps to the beginning.

An entry is pushed into the FIFO block 64 when a blended pixel from the multi-layer composition engine 50 is ready if the FIFO block is not full. As processing takes place, the FIFO block 64 progressively is filled with blended pixels, which subsequently are pushed out of the FIFO 64 to be sent to the display device 30. The fill-level of the FIFO block 64 thus may vary. In general, a decrease in the fill-level of the FIFO block 64 indicates that more pixels are being consumed than are produced.

The timing engine 70 provides, in some implementations, a fully programmable horizontal and vertical synchronization interface. For example, each active display device that is connected to the MCU 20 typically has its own timing requirements and resolution (e.g., 480×272, 800×480 (WVGA), 1280×720 (HD720), 1920×1080 (HD1080)). When the display controller 28 is coupled to a display device 30, a set of registers is programmed to meet the display constraints (e.g., clock polarity, clock divider (to set the pixel clock), horizontal and vertical synchronization pulse width, vertical front and back porch, horizontal and vertical porch width, number of pixels per line and number of rows per frame, signals polarity, and number of bits per pixel). These parameters, which can be located in a display controller user interface, can be programmed at initialization using the CPU 22.

Signals from a timing control engine 72 (e.g., a pixel clock) can be used to trigger sending the pixel data from the display controller 28 to the display 30. In some instances, the timing control engine 72 receives one or more input signals, which for clarity, are not shown in FIG. 2. Examples of the input signals include a clock polarity signal, a clock divider signal to set a pixel clock, horizontal and vertical synchronization pulse width signals, vertical front and back porch signals, horizontal and vertical porch width signals, signals indicating the number of pixels per line, the number of rows per frame, and the number of bits per pixel. Other input signals can include regulation levels to adjust the triggers for the dynamic quality of service signals, as well as the final pixel stream through the FIFO 64, which can be, for example, a one or two pixel-per-clock stream. In some implementations, the timing control engine 72 receives fewer than all of the foregoing input signals and/or may receive additional input signals.

In some cases, the pixel size of the display device 30 does not match the common format of the pixels stored in the FIFO 64. For example, the common format may be 24-bpp, whereas the format of the display screen 30 may be, for example, 12-bpp, 16-bpp, 18-bpp or 24-bpp. The display controller 28 thus provides a final pixel format conversion through operations of the timing engine 72, which takes each pixel in 24-bpp common format and creates a 12-bpp, 16-bpp, 18-bpp or 24-bpp (no change) pixel, depending on the format required by the display device 30. In some instances, when converting from 24-bpp to a lower bpp format, the timing engine 72 discards the least significant bits. As such an operation can create visible artifacts, spatial and/or temporal dithering can be performed by a dithering engine 68. Thus, in the illustrated example, the targeted resolution of the display controller 28 can be up to 1024×768 pixels, such that the illustrated display controller 28 can support, for example, a 12-, 16-, 18- and/or 24-bit output mode through the dithering engine 68.

When an instruction to display an active area is reached, pixels are read from the FIFO block 64 at a display rate (e.g., a pixel clock rate). In the case of a low-voltage differential signaling (LVDS) interface, more than one pixel can be read at a time. If a pixel is missing (e.g., the FIFO block 64 has an empty condition), the display is corrupted, and an interrupt signal can be generated. The overall display screen 30 can be divided into several areas, for example, vertical back and front porch, horizontal back and front porch, and active area. Porch areas represent display areas where pixels are not being read from the FIFO block 64, but may be required for the LCD screen 30. In accordance with the illustrated implementation, the display controller 28 can read an image through the DMA master interface 55. The display controller 28 then can format the display data, perform blending if required, and write the final pixel into the output FIFO block 64. The pixels then can be provided to the display screen 30.

In general, the display controller 28 is considered to be latency critical because it needs to have sufficient access to the system interconnect 34 so as to be able to transfer a complete frame without interruption. In contrast to the display controller 28, the graphics engine 26 in the illustrated example is not latency critical. For example, in some implementations, it is not critical for the display appearing on the display screen 30 if the graphics engine 26 takes more than 16 milliseconds (ms) to render a scene because the system can smoothly transition with only 20-30 frames per second (fps). Thus, if the graphics engine 26 renders at a rate, for example, of only 1, 2 or 5 fps, it is not necessarily critical for the display. More generally, the graphics frame rate is not correlated with the fixed LCD refresh rate; rather, performance of the graphics engine 26 is primarily limited by the memory bandwidth.

To help ensure that the display controller 28 has sufficient access to the system interconnect 34 to allow the display controller to transfer data for a complete frame without interruption, the fill-level of the FIFO block 64 is monitored continuously in a closed loop fashion. If the fill-level of the FIFO block 64 is below a predefined threshold, a regulation signal is provided on a dedicated line 46 to the bus interfaces 36A-36D for the other masters (e.g., the CPU 22, the DMA controller 24 and the graphics engine 26) to control at least one of the rate or bandwidth of the other masters' transactions over the system interconnect 34. By regulating access to the system interconnect 34 in this manner, the regulation signal can help prevent the system interconnect 34 from becoming saturated with access requests from the other masters 22, 24, 26.

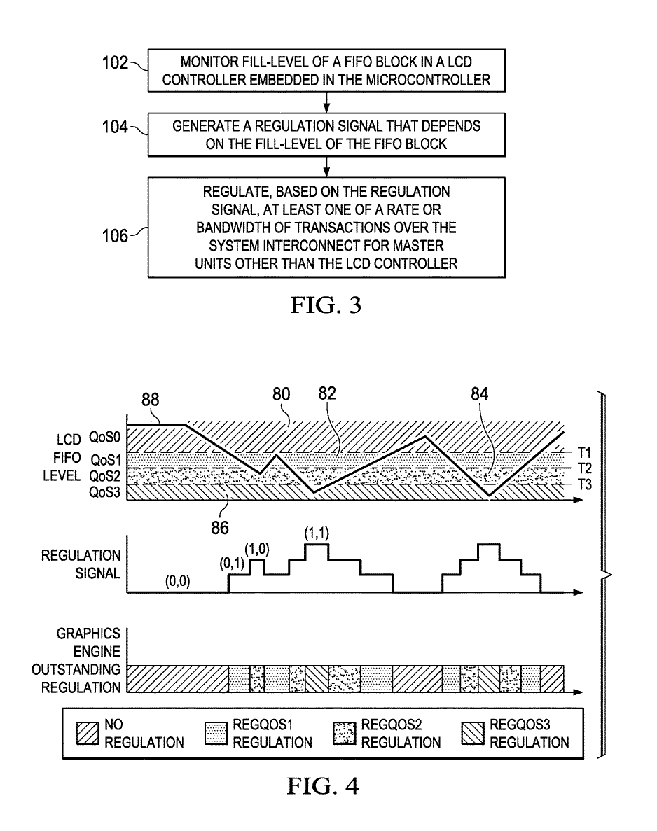

The following paragraphs describe further details according to some implementations of a method of managing access to the system interconnect 34. As indicated by FIG. 3, the method can include monitoring the fill-level of the FIFO block 64 in a display controller 28 embedded in the microcontroller (102), generating a regulation signal that depends on the fill-level of the FIFO block (104), and regulating, based on the regulation signal, at least one of a rate or bandwidth of transactions over the system interconnect for master units other than the display controller (106). The regulation signal can thus regulate (e.g., limit) access to the system interconnect 34 by the other master devices 22, 24, 26.

As noted above, the fill-level of the FIFO block 64 can be monitored to track the number of pixels held in the FIFO block at any given time. Further, the space of the output FIFO block 64 can be divided, for example, into N multiple regions based on N-1 programmable threshold values, where N is a positive integer equal to two or more.

FIG. 4 illustrates an example in which the space of the FIFO block 64 is divided onto N=4 regions depending on the fill-level of the FIFO block. For example, a first region 80 is defined for situations in which the fill-level of the FIFO block 64 exceeds a first threshold T1. The first region 80 represents a condition in which the load on the system interconnect 34 from the FIFO block 64 is sufficiently low such that the output of the other masters (e.g., the graphics engine 26) need not be regulated. A second region 82 is defined for situations in which the fill-level of the FIFO block 64 exceeds a second threshold T2, but is equal to or less than the first threshold T1. A third region 84 is defined for situations in which the fill-level of the FIFO block 64 exceeds a second threshold T2, but is equal to or less than the first threshold T1. A fourth region 86 is defined for situations in which the fill-level of the FIFO block 64 exceeds a third threshold T3, but is equal to or less than the second threshold T2. In this case, T1>T2>T3. In some cases, the thresholds can be programmed such that fill-levels in the first region 80 are more than ⅞ of the total depth of the FIFO block 64, fill-levels in the second region 82 are more than ¾ of the depth of the FIFO block, and fill-levels in the third region 84 are more than ½ of the depth of the FIFO block. Different thresholds can be established for other implementations.

In operation, the display controller 28 generates a regulation signal that depends on the current fill-level 88 of the FIFO block 64. In general, depending on the implementation, there may be two or more different fill-levels defined and monitored. The size (e.g., number of bits) of the signal generated by the regulation signal generator 74 will depend on the number of different fill-level regions for the particular implementation.

Assuming, as in the illustrated example, the regulation signal is a two-bit signal, then when the fill-level 88 of the FIFO block 64 is in the first region 80, the regulation signal generator 74 generates a regulation signal having a first digital value (e.g., 00). The fill-level 88 of the FIFO block 64 enters the other regions 82, 84, 86 as the load on the system interconnect 34 increases. Thus, if the fill-level 88 of the FIFO block 64 is in the second region 82, the regulation signal generator 74 generates a regulation signal having a second digital value (e.g., 01). If the fill-level 88 of the FIFO block 64 is in the third region 82, the regulation signal generator 74 generates a regulation signal having a digital third value (e.g., 10). If the fill-level 88 of the FIFO block 64 is in the fourth region 82, the regulation signal generator 74 generates a regulation signal having a fourth digital value (e.g., 11). In the illustrated example, a situation in which the fill-level 88 enters the fourth region 86 is considered to be critical because the display controller 28 may not have enough pixels, which can lead to corruption of the display.

Each respective value for the regulation signal corresponds to a different level of quality of service (QOS) regulation. For example, when the fill-level 88 of the FIFO 64 is in the first region 80 (e.g., the fill-level is greater than the threshold T1), there is no need for regulation of the other masters (e.g., the graphics engine 26). In that case, the amount of information that the graphics engine 26 (or other masters) can place on the system interconnect 34 is not bounded. On the other hand, when the fill-level 88 of the FIFO 64 is in the second region 82 (e.g., the fill-level is greater than the threshold T2, but not greater than T1), the ability of the other masters (e.g., the graphics engine 26) is throttled so as to reduce the rate and/or bandwidth consumed by those other masters. Likewise, when the fill-level 88 of the FIFO 64 is in the third region 84 (e.g., the fill-level is greater than the threshold T3, but not greater than T2), the ability of the other masters (e.g., the graphics engine 26) is throttled to a greater extent so as to reduce the rate and/or bandwidth consumed by those other masters even further. Finally, when the fill-level 88 of the FIFO 64 is in the fourth region 86 (e.g., the fill-level is not greater than the threshold T3), the ability of the other masters (e.g., the graphics engine 26) is throttled to an even greater extent so as to reduce the rate and/or bandwidth consumed by those other masters even further. Thus, the extent of QOS regulation is greatest when the fill-level 88 enters the fourth region.

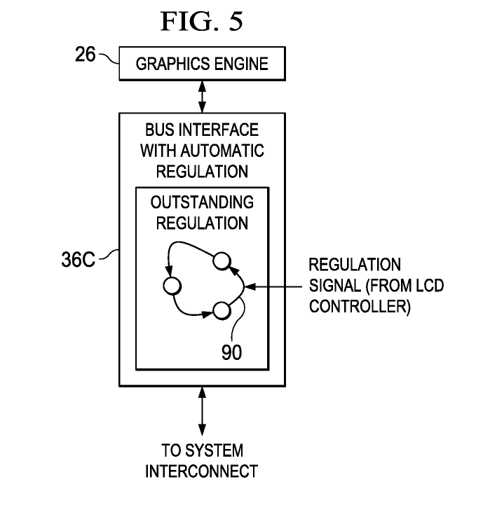

The regulation signal is forwarded to the bus interfaces 36A-36C for the other masters in the microcontroller (e.g., the CPU 22, the DMA controller 24 and the graphics engine 26) and is used to control the rate and bandwidth of the other masters' transactions on the system interconnect 34. To accomplish this task, the regulation signal can be inserted into a respective state machine in each master bus interface. For example, as shown in FIG. 5, the regulation signal from the display controller 28 can be inserted into the state machine 90 of the bus interface 36C for the graphics engine 26. In some implementations, the regulation signal received by the bus interface 36A for the graphics engine 26 (or other master) is loaded into a counter to limit the rate and bandwidth of the other masters' transactions on the system interconnect 34 based on the fill-level of the FIFO block 64. If the regulation signal indicates that the fill-level of the FIFO 64 is in a region other than the first region 80 (e.g., the fill-level is equal to or less than the threshold T1), the BFU is modified and the rate of the state machine 90 is throttled (e.g., reduced). The result is that the graphics engine 26 places less information onto the system interconnect 34. The regulation signal impacts the state machines of the other master bus interfaces in a similar manner. The microcontroller 20 thus can be operable to regulate the pace of the graphics automatically when the display controller 28 requires, for example, more than 50% of the system bandwidth to run flawlessly. The technique can, in some cases, help prevent the display from suffering pixel underrun.

In some instances, metrics registers in the display controller user interface can provide feedback about the behavior of the display controller 28 on a per frame basis. The fields can be updated, for example, on the vertical synchronization signal. The registers indicate the number of pixels sampled in any given threshold. The graphics engine 26 also can provide access to metrics to evaluate the bus load per threshold.

In some cases, the FIFO block also can be used to cross the clock domain boundary. For example, the push domain can be the display controller clock (or the bus system clock), and the pop domain can be the LCD timing engine that feeds the display at the desired display rate. The two domains can be fully asynchronous in some implementations. For example, in some instances, push operations take place at 166 MHz, and pop operations for the pixels take place at a screen pixel frequency of 67 MHz.

Some implementations provide one or more of the following advantages. For example, the microcontroller can be operable to regulate the pace of a graphics automatically when the display controller requires, e.g., more than 50% of the system bandwidth to run flawlessly. The technique can, in some cases, help prevent the display from suffering pixel underrun. Further, in some instances, the dynamic regulation technique described here can obviate the need to make estimations to throttle the masters manually. Further, the regulation mechanism can be transparent when the display controller does not require a lot of bandwidth.

Various modifications will be apparent within the spirit of the foregoing description. Thus, other implementations are within the scope of the claims.

What is claimed is:

1. A display controller comprising:
a first in, first out (FIFO) block; and
a regulation signal generator coupled to the FIFO block, the regulation signal generator operable to generate a regulation signal based on a fill-level of the FIFO block, wherein the regulation signal is configured to regulate access, by a master unit, to a system interconnect.

2. The display controller of claim 1 wherein the regulation signal is configured to modify operation of a state machine of the master unit.

3. The display controller of claim 1 the regulation signal generator is operable to generate the regulation signal having a value that corresponds to one of a plurality of different fill-level regions for the FIFO block depending on the fill-level of the FIFO block.

4. The display controller of claim 3 wherein the regulation signal generator is operable to generate a regulation signal of a first value when the fill-level is within a first one of the regions, to generate a regulation signal of a second value when the fill-level is within a second one of the regions, and to generate a regulation signal of a third value when the fill-level is within a third one of the regions.

5. The display controller of claim 1 wherein the FIFO block is operable as a circular queue that includes a write pointer that is updated when pixel data is written to the FIFO block and a read pointer that is updated when pixel data is read from the FIFO bock.

6. The display controller of claim 1 wherein:
the FIFO block is operable as a circular queue that includes a read pointer and a write pointer, and
the regulation signal generator is operable to monitor the full-level of the FIFO block based on a difference in respective positions of the read and write pointers.

7. The display controller of claim 6 wherein the read pointer is operable to be updated when a pixel is read from the FIFO bock and the write pointer is operable to be updated when a pixel is written to the FIFO block.

8. The display controller of claim 1 further including:
one or more buffers to store image data;
a plurality of pixel pipelines coupled to the one or more buffers, wherein each of the pixel pipelines is operable to process image data received from the one or more buffers; and
a multi-layer composition engine having inputs coupled to the plurality of pixel pipelines, the multi-layer composition engine operable to blend together image data from the plurality of pixel pipelines so as to produce a blended pixel, and to provide the blended pixel to the FIFO block.

9. The display controller of claim 8 wherein the pixel pipelines are operable to convert the image data to a common pixel format used by the multi-layer composition engine.

10. A method comprising:
monitoring a fill-level of a first in, first out (FIFO) block in a display controller;
generating a regulation signal that depends on the fill-level of the FIFO block; and
regulating, based on the regulation signal, access to a system interconnect by a master unit other than the display controller.

11. The method of claim 10 including forwarding the regulation signal to a bus interface for the master unit.

12. The method of claim 11 wherein the regulation signal is inserted into a state machine in the bus interface.

13. The method of claim 10 wherein access to the system interconnect by the master unit increases as the fill-level of the FIFO block falls below one or more predefined thresholds.

14. The method of claim 10 wherein access to the system interconnect by the master unit is controlled dynamically based on the fill-level of the FIFO block.

15. The method of claim 10 wherein the regulation signal is a two-bit signal.

16. The method of claim 10 wherein a value of the regulation signal corresponds to one of a plurality of different fill-level regions for the FIFO block.

17. The method of claim 16 including:
regulating access to the system interconnect for the master unit by a first amount when the fill-level is within a first one of the regions;
regulating access to the system interconnect for the master unit by a second amount when the fill-level is within a second one of the regions; and
regulating access to the system interconnect for the master unit by a third amount when the fill-level is within a third one of the regions.

18. The method of claim 10 including writing blended pixels to the FIFO block and subsequently providing the blended pixels to a display.

19. A microcontroller comprising:
a bus;
an embedded display controller coupled to the bus and operable as a master unit for reading pixel data, the display controller including an output first in, first out (FIFO) block to which pixel data is operable to be written and from which the pixel data is operable to be read and provided to a display device; and
one or more other master units coupled to the bus;
wherein the display controller includes a regulation signal generator operable to monitor a fill-level of the FIFO block and to generate a regulation signal that depends on the fill-level of the FIFO block, wherein the regulation signal is configured to regulate access to the bus by the other one or more master units.

20. The microcontroller of claim 19 further including:
a bus interface coupled between the bus and the other one or more master units, wherein the bus interface is operable to receive the regulation signal and, in response to receiving the regulation signal, to limit access of the one or more master units to the bus; and
a dedicated line configured to transfer the regulation signal from the display controller to the bus interface.
